(19) United States
(12) Patent Application Publication
(10) Pub. No.: US 2006/0059800 A1
(43) Pub. Date: Mar. 23, 2006

(54) Curved window assembly and method of formation

(76) Inventor: Mearl J. Minter, Oskaloosa, IA (US)

Correspondence Address: BRETT J. TROUT, PC, 516 WALNUT, DES MOINES, IA, 50309, US

(21) Appl. No.: 10/918,669

(22) Filed: Aug. 12, 2004

(51) Int. Cl. E06B 3/00

(52) U.S. Cl. 52/204.5

(57) ABSTRACT

A window frame assembly for having a plurality of blocks secured to a flexible mat to form a subassembly. The subassembly is positioned within a rigid frame cover and the frame cover and subassembly are passed through a roll former to create a window frame of any desired curvature. The blocks are of a composite material and are preferably pultruded to provide the insulation and non-condensation advantages associated with wood core window frame, while eliminating the disadvantages associated with mildew, rot, cracking and flammability.

### BACKGROUND OF THE INVENTION

1. Field of the Invention

This invention relates to a curved window frame assembly and its manufacture and, more particularly, to a curved window assembly and method of manufacture utilizing flexible mats and water impervious core blocks to create water impervious curved window assemblies of various dimensions.

2. Description of the Prior Art

It is known in the art of window manufacturing to provide solid core window frames to increase the insulative capability and condensation control associated with the window frame. It is also known in the art to provide windows with aluminum cladding, which may be coated with baked enamel to resist weathering. It is becoming increasingly desirable to provide substantial architectural variety in the aesthetic appearance of window frames. One particularly desirable architectural feature is a curved window frame which either may be associated with a stand-alone window or may be used to top another fenestration assembly. While such curved window frames may be constructed of solid wood, the cost associated with the solid wood itself, the intensive labor and the waste associated with such construction, makes solid wood curved frames prohibitively expensive for most construction projects. Additionally, as wood does not have weather rot and mildew resistance associated with aluminum cladding, solid wood windows do not typically provide the longevity associated with aluminum-clad windows.

It is also known in the art to create curved frame units from fiberglass. A mold for the desired size frame is constructed and fiberglass is applied to create a composite in the mold. The

### SUMMARY OF THE INVENTION

An object of this invention, to provide a solid-core, aluminum-clad window in desired shapes, such as semi-circular arches, gothic peaks, elliptical arches, full circles, and a variety of other desirable shapes.

Another object of this invention is to provide a method of manufacturing a solid-core, aluminum clad window, which provides for low-cost, high volume window production.

Still another object of this invention is to produce curved solid-core windows of various radii with a minimal amount of tooling.

It is yet another object of this invention to provide solid-core, aluminum clad window frames which are weather, rot, mildew, crack and fire resistant.

Accordingly, in a preferred embodiment of this invention, a window frame assembly is provided having a rigid arcuate frame member coupled to a subassembly. The subassembly is preferably a flexible, water impervious mat coupled to a plurality of individual window frame core blocks, each having opposite first and second ends, opposite sites, a top and a bottom. The blocks are secured serially to the flexible, water impervious mat. The subassembly is secured to the rigid arcuate frame member such that the first ends of the blocks are covered by the rigid arcuate frame member, and such that the tops and bottoms of the blocks form a substantially continuous curve, approximating a curve of the rigid arcuate frame member.

In the preferred embodiment, an aluminum extrusion is cut to the desired length, and the subassembly is secured within the aluminum extrusion. The subassembly is preferably constructed of a pultruded mat coupled to a plurality of pultruded individual window frame core blocks. Once the subassembly has been secured within the aluminum extrusion, the resulting frame assembly is passed through a roll former or the like to bend the frame assembly to the desired radius. Once the frame assembly has been bent to the desired radius, an exterior curved frame composite, preferably a pultruded material, is bonded to the outer surface of the frame assembly utilizing adhesive or similar securement means. Interior edging composite, again preferably a pultruded material, is then bonded to the interior surface of the frame assembly opposite the aluminum extrusion. The frame assembly is then cut at a forty-five degree or other desired angle and attached to a sill composite, preferably constructed of a pultruded material. The resulting frame assembly is then painted any desired color and installed in a manner such as that known in the art for installing curved, solid core frame assemblies.

### BRIEF DESCRIPTION OF THE DRAWINGS

The present invention will now be described, by way of example, with reference to the accompanying drawings in which:

FIG. 1 illustrates a front elevation of a window frame constructed in accordance with the method of the present invention, with muntin bars in a sunburst pattern;

FIG. 2 illustrates a side elevation in cross-section of the window frame assembly of FIG. 1, taken along line 2-2 of FIG. 1;

FIG. 3 illustrates a top perspective view of a subassembly of the window frame assembly of the present invention;

FIG. 4 illustrates a side elevation in cross-section of the subassembly of the window frame assembly coupled into the aluminum frame, and the exterior curved frame composite secured thereto;

FIG. 5 illustrates an alternative embodiment of a subassembly of the present invention, utilizing a solid block to produce an integrated flexible mat and core blocks.

### DETAILED DESCRIPTION OF THE PREFERRED EMBODIMENT

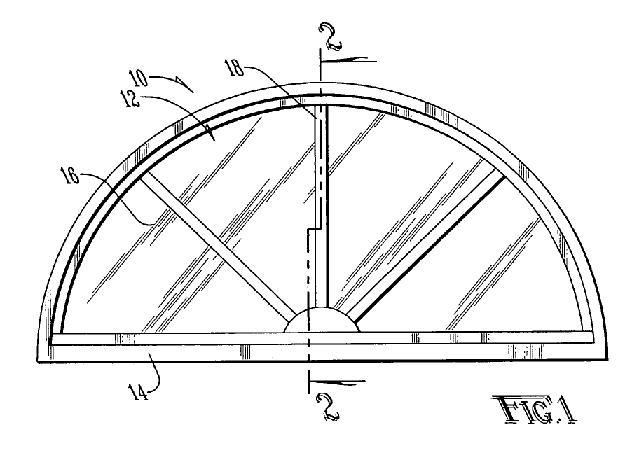

The window frame assembly of the present invention is shown generally as (10) in FIG. 1. The window frame assembly (10) is incorporated into a semi-circular, fixed panel window (12). The window frame assembly (10) may, of course, be incorporated into any desired window, of any desired radius or configuration, including, but not limited to, circular windows, oval windows and windows with undulating curved perimeters. The window includes the curved window frame assembly (10) and a straight sill assembly (14) which define an area containing insulating glass contained by the window frame assembly (10) and sill assembly (14). Muntin bars (18) are releasably mounted in a sunburst pattern on the interior of the window (10).

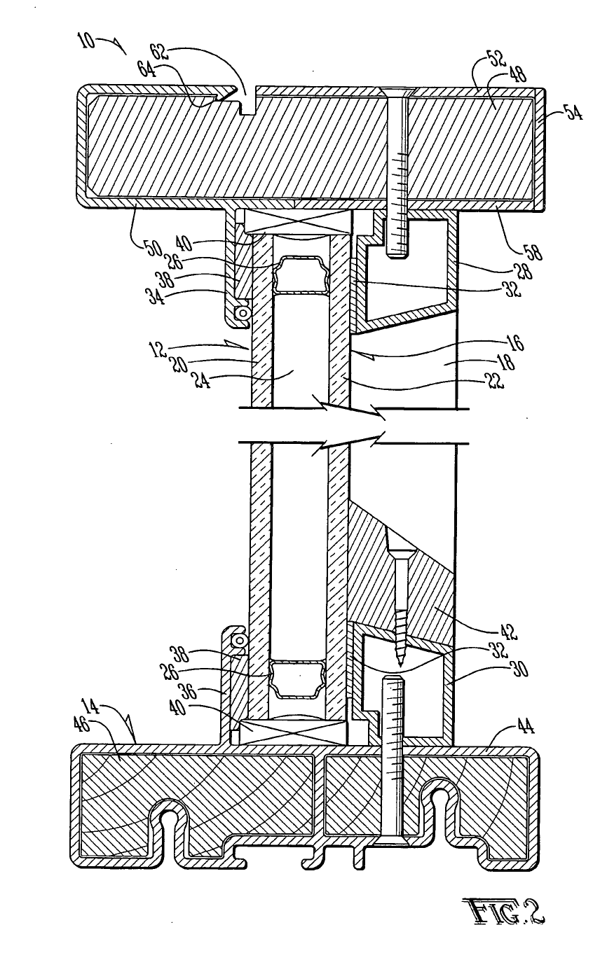

As shown in FIG. 2, the exterior side of the window (12) is to the left and the interior is to the right. The window glass (16) includes two panes (20) and (22), defining an interposed airspace (24) and separated by spacers (26). The window glass (16) is held in position on the interior frame by a pultruded interior glazing stop (28), screwed into or otherwise secured to the curved frame assembly (10), and a pultruded interior sill glazing stop (30), screwed into or otherwise secured to the sill assembly (14). Polyvinylchloride foam tape (32) insulates between the window (16) and the stops (28) and (30). From the exterior, the window (16) is held to the frame by the curved, extruded aluminum exterior frame flange (34), and a pultruded frame flange (36) integrally formed with the cladding of the sill frame assembly (14). The window facing edges of the flanges (34) and (36) are separated from the flanges (34) and (36) by butyl sealant (38) which also seals any gaps between the flanges (34) and (36) and the window (16). Setting blocks (40) support and provide for the setting of the window (16). The sunburst (42) is screwed into or otherwise secured to the interior sill stop (30).

The sill of the sill frame assembly (14) comprises a one-piece sill frame (44) surrounding wooden cores (46). FIG. 2. The sill frame (44) may be constructed of pultruded material or any desired weather resistant material.

In the preferred embodiment, the frame assembly (10) includes a plurality of core blocks (48) and a curved extruded aluminum frame cover (50). (FIG. 2). Although the core blocks (48) may be constructed of any suitable material, in the preferred embodiment, the core blocks (48) are produced of a composite material. The core blocks (48) may be constructed of any desired composite, such as fiber and resin, nylon, fiberglass, wood flour and resin, or any similar material, and may be pultruded with a rectangular cross-section, a chamfered octagonal cross-section, or any other desired configuration. Preferably, the core blocks (48) are constructed of a water impervious material wherein water may penetrate the material, but will not rot the material. The core blocks (48) are preferably not only weather resistant and fire resistant, but resist cracking and aid in insulating and reducing condensation associated with the frame assembly (10). The core blocks (48) provide the core of the frame assembly (10) and the curved frame cover (50) provides an aluminum clad exterior for the frame assembly (10). An exterior curved frame composite (52) is secured by adhesive or other means to the tops of the core blocks (48). Adhesively or otherwise secured to a portion of the under side of the core blocks (48) is a curved frame composite material (58). The curved frame composite material (58) is preferably a thin layer of pultrusion, ranging in thickness from preferably 0.005 to approximately 0.25 inches in thickness, more preferably 0.010 to 0.125 inches, and most preferably from 0.015 to 0.05 inches in thickness. While the curved frame composite material (58) is preferably pultrusion, the mat may be constructed of thin vinyl, fiberglass or any other suitable strong, flexible, weather resistant material. As shown in FIG. 2, when the core blocks (48) are positioned within the frame cover (50), the composite material (58) meets flush with the frame cover (50) to create an even surface. A composite edge band (54) constructed of pultrusion, fiberglass or similar weather and rot resistant material is adhesively secured to the horizontal, interiormost surface of the core blocks (48) to provide a smooth interior face for the frame assembly (10).

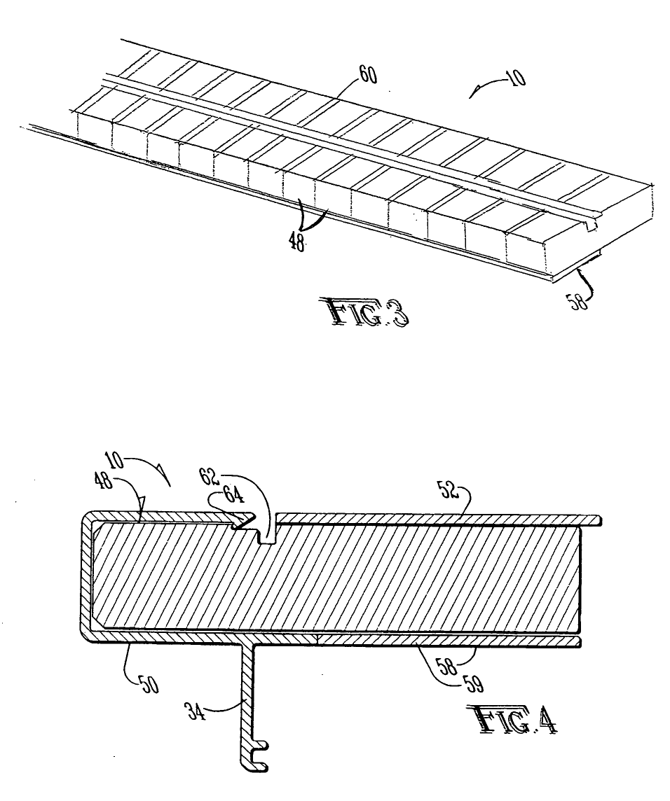

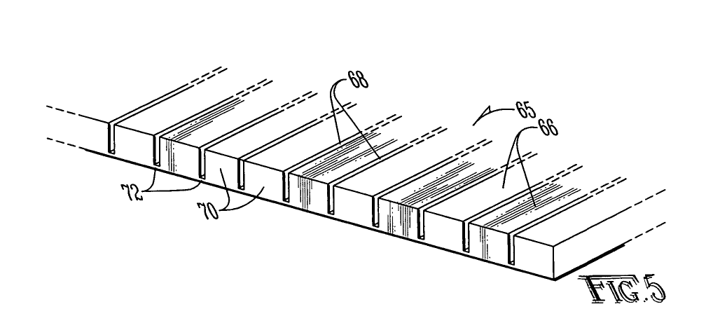

The sill frame assembly (14), window panel (16) and components of the window (12), other than the frame assembly (10), are formed in a conventional manner such as that known in the art. The frame assembly (10) is formed as follows, with reference to FIGS. 3 and 4. The curved frame cover (50) is extruded of aluminum, with the profile shown in FIG. 2, incorporating the frame flange (34). The extrusion is then cut to the desired length. The curved frame composite material (58) is pultruded and cut to the same length as the frame cover (50). The curved frame composite material (58) is then passed through a glue spreader (not shown) and laid on a flat surface. The core blocks (48) are then formed to their desired shape and then cut to the desired length. While the core blocks (48) may be cut to the desired thickness of the frame assembly (10), alternatively, the curved frame composite material (58) and core blocks (48) may be constructed of much greater thickness and then, once secured to one another, cut into a plurality of subassemblies as opposed to making one subassembly at a time. The core blocks (48) are glued serially along the curved frame composite material (58). The core blocks (48) are elongated and most preferably have a rectangular cross-section of dimensions about one inch by three/fourths of an inch. As shown in FIG. 3, the core blocks (48) are pultruded with an octagonal cross-section to produce chamfered edges. The core blocks (48) are laid on the curved frame composite material (58), transverse to the width of the curved frame composite material (58). That is, the core blocks (48) are placed on the curved frame composite material (58) such that the longest dimension of the core blocks (48) is at a right angle to the longest dimension of the curved frame composite material (58). The core blocks (48) are preferably glued into tight physical contact with one another.

The curved frame composite material (58) may have a length and width sufficient to form a single frame assembly (10). (FIG. 2). More preferably, the curved frame composite material (58) is provided with a length sufficient to form two-and-two frame assemblies (10), and a width sufficient to form two side-by-side frame assemblies (10). As the result, four frame subassemblies (60) may be cut from the resulting curved frame composite material (58) and core block (48) assembly. Similarly, the core blocks (48) have a length sufficient to form two subassemblies (60) and are provided in a number sufficient to cover substantially the complete length of the curved frame composite material (58). FIG. 3. Once the assembly has been cut to form four subassemblies (60) for four frame assemblies (10), a groove or slot (62) is routed along each subassembly (60) through the core blocks (48). FIG. 2. Each of the core blocks (48) is provided with a slot (62), aligned with the slots of all of the other core blocks (48). The slots (62) provide for mating of the subassembly (60) of the frame cover (50).

At this stage, the subassembly (60) is flexible, and may be curved in a circle with the core blocks (48) outward of the curved frame composite material (58). (FIG. 2). In this condition, the subassembly (60) is slid into the frame cover (50). A frame cover flange (64) of the cover (50) slides along and into the core block slots (62), retaining the subassembly (60) against separation from the cover (50). The core blocks (48) are thus secured to the frame cover (50) such that the subassembly (60) assumes the profile of the frame cover (50). The frame cover (50) and subassembly (60) are then passed through a roll-former or other similar mechanism and bent to the desired radius. Once the desired radius has been achieved, the exterior curved frame composite (52) is secured by adhesive to the top of the core blocks (48). The exterior curved frame composite (52) preferably cantilevers somewhat over the edge of the core blocks (48) and are thereafter cut back to the desired length to provide the exterior curved frame composite (52) with the exact profile of the core blocks (48). The composite edge band (54) is secured by adhesive to the interior faces of the core blocks (48). Preferably, the edge band (54) is installed in segments having mating ends and straight sides which are routed to the curved shape of the frame assembly (10). The edge band (54) hides from view the edges of the curved frame composite material (58), and the exterior curved frame composite (54). The composite edge band (54) may be longer than the faces of the core blocks (48). Preferably, after the exterior curved frame composite (52) and composite edge band (54) have been adhesively secured, the overhanging edges are routed to make the edges even with the core blocks (48). Thereafter, the window frame assembly (10) is secured to the sill assembly (14) in a manner such as that known in the art.

An alternative subassembly is shown generally as (65) in FIG. 5. As shown, a pultruded block (66) is provided of a height, width and depth similar to that of the subassembly (60) described above. The block (66) may instead be constructed of any desired material, such as wood flour and resin or a similar flexible, weather resistant and fire resistant material. As shown in FIG. 5, a saw (not shown) is used to provide a plurality of kerfs (68) in the block (66). The kerfs (68) are cut to a depth sufficient to allow the resulting spine (70) to act in a manner similar to that of the curved frame composite material (58) described above. The spine (70) may be of varying dimensions, but is preferably thick enough to support the core blocks (72) defined by the kerfs (68), yet narrow enough to allow the subassembly (65) to be curved to the desired radius without breaking along any of the kerfs (68).

Although the invention has been described with respect to a preferred embodiment thereof it is also to be understood that it is not to be so limited, since changes and modifications can be made therein which are within the full, intended scope of this invention as defined by the appended claims. For example, the method of the present invention may be utilized to produce windows of any desired dimensions and configurations, including circular, peaked gothic, elliptically peaked and other desired configurations.

What is claimed is:

1. A window frame assembly comprising:
(a) a rigid arcuate frame member;
(b) a flexible water impervious mat;
(c) a plurality of individual window frame core blocks, each having opposite first and second ends, opposite sides, a top and a bottom, and said blocks being secured serially to said flexible water impervious mat;
(d) wherein said core blocks and said flexible water impervious mat form an elongated subassembly secured to said rigid arcuate frame member such that said first ends of said blocks are covered by said rigid arcuate frame member; and
(e) wherein such that said tops and said bottoms of said blocks form a substantially continuous curve approximating a curve of said rigid arcuate frame member.

2. The window frame assembly of claim 1, wherein each of said core blocks is provided with a slot aligned with slots of other core blocks, wherein said rigid arcuate frame member is provided with a flange, and wherein said subassembly is secured to said rigid arcuate frame member by engagement of said flange with said core blocks in said slots.

3. The window frame assembly of claim 1, wherein said plurality of core blocks are constructed of a pultruded material.

4. The window frame assembly of claim 1, wherein said plurality of blocks are constructed of a non-porous material.

5. The window frame assembly of claim 1, wherein said plurality of blocks are constructed of a rot resistant material.

6. The window frame assembly of claim 1, wherein said plurality of core blocks are provided with at least one chamfered edge.

7. The window frame assembly of claim 1, wherein said plurality of core blocks are chamfered to create an octagonal cross-section.

8. The window frame assembly of claim 1, wherein said plurality of core blocks comprise:
(a) resin; and
(b) a plurality of fibers secured in relationship to one another by said resin.

9. The window frame assembly of claim 8, wherein said plurality of core blocks comprise:
(a) resin; and
(b) wood particles secured together by said resin.

10. The window frame assembly of claim 1, wherein said plurality of core blocks are pultruded of resin and fiber, and wherein said rigid arcuate frame member comprises a malleable material.

11. The window frame assembly of claim 1, wherein a block of said plurality of core blocks has at least one dimension at least twice as long as either of the two remaining dimension.

12. A window frame assembly comprising:
(a) a subassembly comprising:
(i) a sheet of material comprising:
(i) resin
(ii) a plurality of fibers secured in relationship to one another by said resin.
(ii) a plurality of core blocks secured to said sheet of material.
(b) a rigid arcuate frame member; and
(c) wherein said subassembly is secured to said rigid arcuate frame member in a manner in which said subassembly assumes the arcuate shape of said frame member.

13. A window frame assembly comprising:
(a) a subassembly comprising:
(i) a flexible mat; and
(ii) a plurality of core blocks integrally formed with said flexible mat;
(b) a rigid arcuate frame member; and
(c) wherein said subassembly is secured to said rigid arcuate frame member in a manner in which said subassembly assumes the arcuate shape of said frame member.

14. The window frame assembly of claim 13, wherein said subassembly is formed from a block provided with slits sufficient to define said flexible material and said plurality of core blocks.

15. The window frame assembly of claim 13, wherein said subassembly comprises:
(a) a sheet of material comprising:
(i) resin
(ii) a plurality of fibers secured in relationship to one another by said resin.
(b) a plurality of core blocks secured to said sheet of material.

16. The window frame assembly of claim 13, wherein said subassembly comprises:
(a) resin; and
(b) wood particles secured together by said resin.

17. The window frame assembly of claim 13, wherein said plurality of core blocks are provided with at least one chamfered edge.

18. A method of assembling a window frame assembly comprising:
(a) providing a curved frame member;
(b) providing a subassembly comprising a flexible mat portion coupled to a plurality of core blocks; and
(c) securing said subassembly to said curved frame member in a manner such that said subassembly assumes a curvature of said curved frame member.

19. The method of assembling a window frame assembly of claim 18, further comprising forming said curved frame member from a substantially straight frame member after said subassembly has been secured to said substantially straight frame.

20. The method of assembling a window frame assembly of claim 18, wherein said subassembly comprises:
(a) a flexible mat; and
(b) a plurality of core blocks secured to said flexible mat.

21. The method of assembling a window frame assembly of claim 18, further comprising forming said subassembly from a block by cutting a plurality of slots into said block sufficient to create said flexible mat and said plurality of core blocks.
